(19) United States
(12) Patent Application Publication
(10) Pub. No.: US 2012/0330860 A1
(43) Pub. Date: Dec. 27, 2012

(54) SYSTEMS AND METHODS FOR MONITORING ORDERS IN AN EXCHANGE

(76) Inventor: Douglas L. Foster, II, Chicago, IL (US)

(21) Appl. No.: 13/168,670

(22) Filed: Jun. 24, 2011

(51) Int. Cl. G06Q 40/00

(52) U.S. Cl. 705/36 R

(57) ABSTRACT

A trading computer receives data regarding a change in the inside market for a product traded using a trading host. The computer determines a value of a highest bid price and a value of a lowest ask price and displays the values of the highest bid price and lowest offer price in a first and a second region, respectively, of a display. The trading computer also displays a plurality of values less than the value of the highest bid price in a first plurality of regions and a plurality of values greater than the value of the lowest offer price in a second plurality of regions. The location of the first region, the second region, the first plurality of regions, and the second region relative to each other remains constant even when the inside market changes.

### BACKGROUND OF THE INVENTION

1. Field of the Invention

The present invention relates generally to trading systems and methods and more particularly, to systems and methods that may be used by a trader to submit orders to an exchange and monitor activities in an exchange.

2. Description of the Background of the Invention

An exchange provides one or more markets for the purchase and sale of various types of products including agricultural products, commodities, and financial instruments such as stocks, bonds, futures contracts, options, currency, and other similar instruments. A futures contract is a contract for the future delivery of a specified quantity of an item at a date or within a range of dates. The item may be another financial instrument, a quantity of a certain grain, metal, natural resource, bonds, or currency. Generally, each exchange establishes a specification for each market provided thereby that defines at least the product traded in the market, minimum quantities that must be traded, and minimum changes in price (e.g., tick size). For some types of products (e.g., futures or options), the specification further defines a quantity of the underlying product represented by one unit (or lot) of the product, and delivery and expiration dates for such products.

Exchanges may use an electronic trading platform (e.g., an electronic exchange) to facilitate trading in a market where traders use software operating on a computer to send an order to the trading platform. The order identifies the product, the quantity of the product the trader wishes to trade, a price at which the trader wishes to trade the product, and a direction of the order (i.e., whether the order is a bid or an offer).

A trading host of the electronic trading platform monitors incoming orders received thereby and attempts to identify (i.e., match) one or more previously received orders, wherein each identified order is contra to the incoming order and has a favorable price relative to the incoming order. In particular, if the incoming order is a bid then the identified order is an offer at a price that is identical to or less than the bid price. Similarly, if the incoming order is an offer at a particular price, the identified order is a bid at a price that is identical to or greater than the offer price. The trading host stores information regarding previously received orders that have not been matched in a database generally referred to as an “order book.” Typically, the trading host maintains a separate order book for each market hosted thereby.

Traders access the markets on a trading platform using trading software that receives and displays at least a portion of the order book for a market, enables a trader to provide parameters for an order for the product traded in the market, and transmits the order to the trading platform. The trading software typically includes a graphical user interface (GUI) to display at least a price and quantity of some of the entries in the order book associated with the market. The number of entries of the order book displayed is generally preconfigured by the trading software, limited by the trading platform, and/or customized by the trader. Some graphical user interfaces display order books of multiple markets of one or more trading platforms.

As the trading software receives information from the exchange regarding pending orders in a market hosted thereby, the graphical user interface of the trading software displays information regarding a sell order for the product pending in the market that has the lowest offer price and a pending buy order that has the highest bid price. The lowest offer price and the highest bid price associated with pending sell and buy orders in a market, respectively, are generally referred to as the inside market.

Typically, a graphical user interface displays the orders for the product by displaying a column of price values. The graphical user interface displays the quantity of the product associated with a pending buy or sell order adjacent to an associated price value. In some cases, the graphical user interface displays the quantities associated with pending buy orders in a column on one side of the column of price values and quantities associated with pending sell orders in another column adjacent another side of the column of price values. In other embodiments the quantities associated with buy and sell orders may be displayed in a single column adjacent to the column of price values and an indicator is used to distinguish a quantity associated with a buy order from a quantity associated with a sell order. In some embodiments, the indicator may be a color used to display the value or the color of a region in which value is displayed. Alternatively, the display of the price values and quantities associated with orders may be displayed in rows instead of columns.

The trading software updates the order information displayed by the graphical user interface thereof as additional order information is received from the trading host. In some systems, the trading software does not typically modify price values displayed in the column of price values as additional order information is received. Instead, the quantities associated with pending orders associated with such price values are modified. In some of these systems, the price values are modified only if a trader issues a command to center the prices associated with the inside market on the display. In other systems, the trading software automatically modifies the price values that are displayed when the highest bid price and/or the lowest offer price are near the top or bottom of the display. In such embodiments, the trading software may center the column of price values in the display so that the inside market is centered on the display.

### SUMMARY OF THE INVENTION

According to one aspect of the present invention, a method of displaying market information includes the step of (a) receiving data regarding a change in the inside market for a product traded using a trading host. The method includes the further steps of (b) determining a value of a highest bid price and a value of a lowest ask price, (c) displaying the value of the highest bid price in a first region of a display, and (d) displaying the value of the lowest offer price in a second region of display. In addition, the method includes the steps of (e) displaying a plurality of values less than the value of the highest bid price in a first plurality of regions and (f) displaying a plurality of values greater than the value of the lowest offer price in a second plurality of regions. The steps (b) through (f) are undertaken each time the data representing a change in the inside market are received and the locations of the first region, the second region, the first plurality of regions, and the second region relative to each other remains constant even when the inside market changes.

According to another aspect of the present invention, a system for displaying market information for a product traded using a trading host includes a screen that includes a first region for displaying a value of a highest bid price for the product and a second region for displaying a lowest offer price for the product. The screen also includes a first plurality of regions for displaying values less than the highest bid price and a second plurality of regions for displaying values greater than the lowest ask price. The system further includes a programmable processor that receives data representing a change in an inside market from the trading host, determines the value of a highest bid price and the value of a lowest ask price from the received data, and displays the value of the highest bid price and the value of the lowest ask price in the first and second regions of the screen. The locations of the first region, the second region, the first plurality of regions, and the second plurality of regions relative to one another remain substantially constant even when the inside market changes.

According to still another aspect of the present invention, an apparatus for displaying market information includes means for repeatedly receiving data regarding a change in an inside market for a product traded using a trading host. In addition, the apparatus includes means for determining a value of a highest bid price and a value of a lowest ask price, means for displaying the value of the highest bid price in a first region of a screen, and means for displaying the value of the lowest ask price in a second region of the screen. The apparatus further includes means for displaying a plurality of values less than the value of the highest bid price in a plurality of regions and means for displaying a plurality of values greater than the value of the lowest offer price in a second plurality of regions. The locations of the first region, the second region, the first plurality of regions, and the second plurality of regions relative to one another remain substantially constant even when the inside market changes.

In a further aspect of the present invention, a computer program product for displaying market information comprises a computer-readable storage medium having computer executable program code stored thereon. The computer executable program code, when executed, causes a computer to (a) receive data regarding a change in an inside market for a product traded using a trading host, (b) determine a value of the highest bide price and a value of a lowest ask price, (c) display the value of the highest bid price in a first region of a screen, (d) display the value of the lowest offer price in a second region of the screen, (e) display a plurality of values less than the value of the highest bid price in a first plurality of regions, and (f) display a plurality of values greater than the value of the lowest offer price in a second plurality of regions. The computer undertakes (b) through (f) each time the data representing a change in the inside market is received and the locations of the first region, the second region, the first plurality of regions, and the second plurality of regions relative to one another remain substantially constant even then the inside market changes.

In a still further aspect of the invention, an apparatus for trading using a trading host includes means for displaying on a screen a first value associated with a highest bid price in the market and a second value associated with a lowest offer price in the market. The apparatus also includes means for receiving a first input in a region of the screen associated with the first value or the second value and means responsive to the receiving means for displaying a third value that is greater than the first value and lest than the second value. In addition, the apparatus includes means for receiving a second input in a region of the screen associated with the third value and means responsive to the second receiving means for transmitting data associated with an order to the trading host. The price associated with the order is determined in accordance with the third value.

### BRIEF DESCRIPTION OF THE DRAWINGS

FIG. 1 comprises a block diagram of a system that may be used for trading;

FIG. 2 comprises a graphical user interface that may be displayed on a screen associated with a trading computer of the system of FIG. 1;

FIG. 3 comprises another graphical user interface that may be displayed on a screen associated with the trading computer of the system of FIG. 1;

FIG. 4 comprises still another graphical user interfaces that may be displayed on a screen associated with the trading computer of the system of FIG. 1;

FIG. 5 comprises yet another graphical user interfaces that may be displayed on a screen associated with the trading computer of the system of FIG. 1;

FIG. 6 comprises a further graphical user interface that may be displayed on a screen associated with the trading computer of the system of FIG. 1;

FIG. 7 is a flowchart of processing undertaken by the trading computer of the system of FIG. 1 to generate the graphical user interfaces of FIGS. 2-6; and

FIG. 8 is flowchart of processing undertaken by the trading computer of the system of FIG. 1 of in response to input received from a user input device associated therewith.

### DETAILED DESCRIPTION

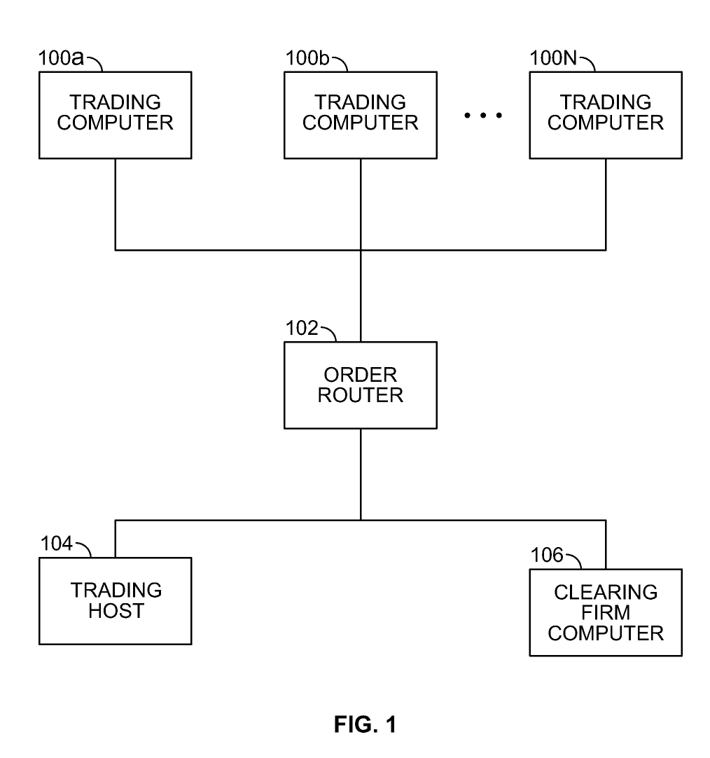

FIG. 1 comprises a block diagram of a system for trading that includes trading computers 100a, 100b, . . . , and 100N with an order routing computer 102. The order routing computer 104 communicates with a trading host 104 and a clearing firm computer 106. Communications between one of the trading computers 100 and the order routing computer 102, and/or between the order routing computer 102 and the trading host 104, and/or between the order routing computer 102 and the clearing firm computer 106 may be undertaken using a public network, such as the Internet, or a proprietary network. The order routing computer 102 may be an individual computer or a system of computers operating together. Similar, the trading host 104, and the clearing firm computer 106 may an individual computers or systems.

A trader enters into one of the trading computers 100 parameters of an order to be sent to the order routing computer 102. The parameters identify a product to be bought or sold, a bid or offer price, respectively, and, possibly, an exchange to which the order should be sent. The trading computer 100 transmits data representing the order to the order routing computer 102. Upon receipt of such data, the order routing computer 102 verifies that the received data represents a valid order and transmits the data to a trading host 104. Before transmitting the data to the trading host 104, the order routing computer 102 may send data regarding the order to the clearing firm computer 106 to confirm that the trader is authorized to trade the product and that such trader has sufficient credit. The order routing computer 102 may transmit data regarding the authorization and credit worthiness of the trader with the data representing the order to the trading host 104.

Upon receiving the data representing the order, the trading host 104 validates the parameters of the order, the authorization, and the credit worthiness of the trader. If the parameters, authorization, and credit worthiness are valid, the trading host 104 attempts to identify one or more previously received orders, or a portion of a previously received order, stored in an order book, wherein each identified order is contra to the incoming order and has a favorable price relative to the incoming order. In particular, if the incoming order is a bid then the identified order is an offer at a price that is identical to or less than the bid price. Similarly, if the incoming order is an offer at a particular price, the identified order is a bid at a price that is identical to or greater than the offer price.

Upon identification of a contra order, a lesser of the two quantities associated with the identified order and the incoming order are matched and that quantity of each of the identified and incoming orders become two halves of a matched trade. The trading host 104 generates data representing the matched trade and transmits such data to a clearinghouse (not shown). The trading host 104 considers each remaining identified order in this manner until either all of the identified orders have been considered or all of any remaining quantity associated with the incoming order has been matched. If any quantity of the incoming order remains unmatched after consideration of all identified orders, an entry is created in the order book to add an order with a price and a bid/offer indication identical to those of the incoming order and a quantity identical to the remaining unmatched quantity of the incoming order. The trading host 104 generates data representing the order added to the order book and transmits such data to the order routing computer 102. The order routing computer 102 thereafter transmits the data representing the order added to the order book to each of the trading computers 100a, 100b, . . . , and 100N.

In some embodiments, the order routing computer 102 transmits data representing the order added to the order book each time such an order is added. In other embodiments, the order routing computer 102 transmits data that represents an added order only if the price associated with such order is within a predetermined range of prices from the inside market. In still other embodiments, the order routing computer 102 aggregates orders added to the order book for a period of time and transmits information regarding the aggregated order upon expiration of such period.

When the trading computer 100 receives the data that represents the order added to the order book, software operating on the trading computer 100 displays information regarding such order on a display of the trading computer 100. In particular, the graphical user interface generated by such software is updated to reflect the order added to the order book by the trading host 104.

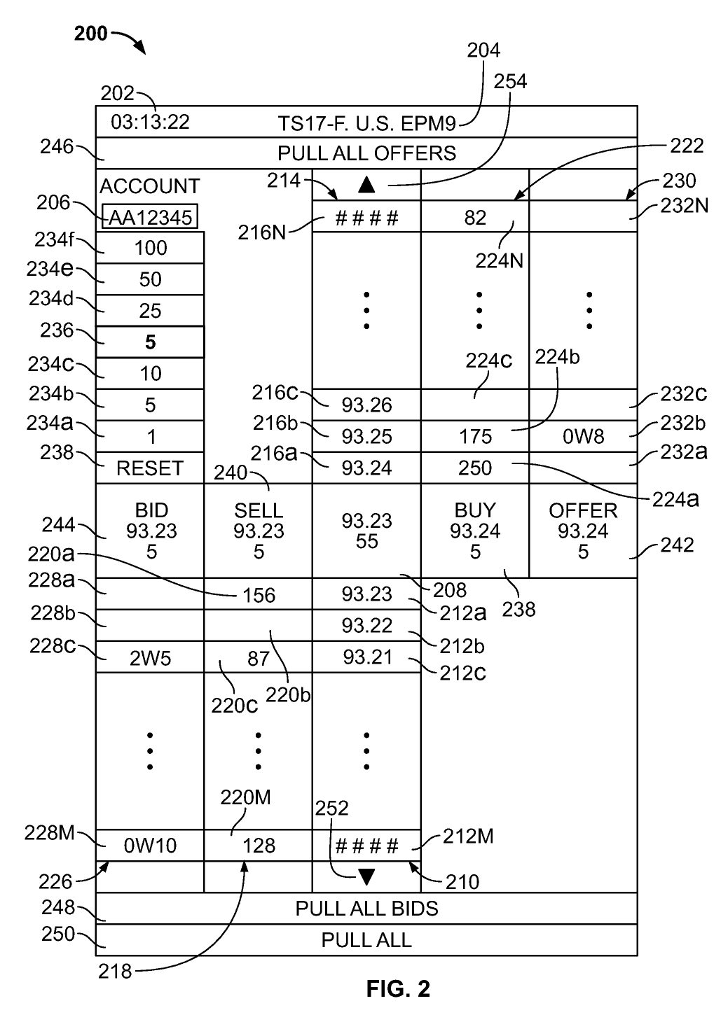

FIG. 2 is a graphical user interface 200 the software operating on the trading computer 100 generates to display orders in an order book associated with a product. Such software allows a trader to specify parameters for an order that is sent to the trading host 104 via the order routing computer 102. The graphical user interface 200 includes a region 202 in which the time when the exchange last provided data is displayed. A region 204 displays information identifying the product associated with the order book information displayed by the graphical user interface 200. The graphical user interface 200 includes a text entry field 206 in which the trader may enter information regarding an account in which trades undertaken by the trader are to be noted.

A region 208 of the graphical user interface 200 shows (or displays) a price at which the most recent trade reported by the exchange took place and a quantity of the product traded at such price. For example, the region 208 represented in FIG. 2 shows 55 units (e.g., contracts, shares, etc.) of the product traded between two traders at a price of $93.23 per unit. A column 201 includes regions 212a, 212b, 212c, . . . , and 212M, in which are displayed values that are less than or equal to the price shown in region 208. In particular, a value of the highest bid price of the orders in the order book for the product is displayed in the region 212a. Typically, a value displayed in region 212b is the value displayed in region 212a less a tick size associated with the product, a value in displayed in region 212c is the value displayed in region 212b less the tick size, and so on in the remaining regions 212 of column 210

A column 214 includes regions 216a, 216b, 216c, . . . , and 216N, in which are displayed prices that are greater than or equal to the price of the last trade shown in region 208. In particular, a value of a lowest offer price of the orders in the order book for the product is displayed in the region 216a. A value determined by adding the tick size to the value displayed in the region 216a is displayed in the region 216b, and so on in the remaining regions 216c, . . . , and 216N of the column 214.

The difference between values shown in adjacent regions of columns 210 and 214 does not have to be the tick price. In some embodiments, such difference may be configurable by the trader using the trading computer 100 or pre-defined in other ways.

A column 218 comprises regions 220a, 220b, 220c, . . . , and 220M and each such region 220a, 220b, 220c, . . . , and 220M is associated with one of the regions 212a, 212b, 212c, . . . , and 212M, respectively. A value is displayed in the region 212a that is the sum of quantities of the product associated with one or more buy orders in the order book at the price displayed in the region 212a, 212b, 212c, . . . , and 212M, respectively. For example, in region 220c, the value 87 is shown to indicate 87 units of the product are associated with one or more orders to buy the product for the price ($93.23) shown in the region 212c. In some embodiments. If there are no orders to buy the product at a price displayed in one of the regions 212, then the region 220 associated therewith a zero or other indicia may be displayed therein or no there may be nothing displayed in the region 220.

A column 222 comprises regions 224a, 224b, 224c, . . . , and 224N, each of which is associated with one of the regions 216a, 216b, 216c, . . . , and 216N, respectively. The quantity, if any, of the product associated with sell orders at the price displayed each of the regions 216a, 216b, 216c, . . . , and 216N is displayed in each of the regions 224a, 224b, 224c, . . . , and 224N, respectively.

A column 226 comprising regions 228a, 228b, 228c, . . . , 228M is associated with the regions 212a, 212b, . . . , 212M, respectively, and the status of buy orders submitted by the trader is displayed such regions. In particular, the quantity of units to be purchased by such buy orders at the price displayed in the region 212 is displayed in a region 228 associated therewith and the quantity of units that have been purchased by matching the buy orders submitted by the trader with sell orders submitted by other traders. For example, the string “2w5” is displayed in the region 220b to indicate that the trader has entered one or more orders to buy 7 units of the product at the price ($93.21) displayed in the region 212c and that 2 of the 7 units have been purchased, and that 5 units remain unmatched in the market (i.e., are still pending). Similarly, the string “0w10” displayed in the region 228M indicates that the trader entered one or more orders to buy 10 units of the product at the price displayed in the region 210 and no units of the product have been purchased and are still pending, that is, none of the buy orders submitted at such price by the trader has been matched with sell orders submitted by another trader.

Column 230 is similar to column 226 described above except that column 230 comprises regions 232a, 232b, 232c, . . . , and 232N in which information regarding quantities associated with one or more sell orders submitted by the trader is displayed.

In addition to displaying status of the orders in the market, the graphical user interface 200 enables the trader to enter parameters for orders to send to the order routing computer 102. Each region 234a, 234b, . . . , and 234f is selectable and has a value displayed therein. When the trader selects one of the regions 234a, 234b, . . . , and 234f, the predetermined value displayed therein is defined as a default quantity for any orders submitted thereafter. Upon receiving selection of one of the regions 234a, 234b, . . . , and 234f, the software displays the quantity displayed in the selected region in the region 236. If the trader selects the region 238 labeled “RESET,” the default quantity for orders submitted thereafter is set to a predetermined value determined by the software or, in some embodiments, preconfigured by the trader using the trading computer 100.

The values of prices displayed in the regions 212a and 216a are the highest bid and lowest offer prices associated for the product (i.e., the inside market for the product) at the time shown in the region 202. When the trading computer 100 receives data indicating that the inside market has changed, the values displayed in the regions 212a and 216a are changed accordingly to display the changed highest bid price and/or lowest offer price.

If the trader clicks in a region 238, the trading computer 100 used by the trader generates and sends to the order routing computer 102 data for an order to buy a quantity identical to the value displayed in the region 236 of the product at the lowest offer price, the value of which is displayed in the region 216a. In the graphical user interface 200 illustrated in FIG. 2, such an order would be to purchase 5 units at a price of 93.24 per unit.

Similarly, if the trader clicks in a region 240, the trading computer 100 generates and transmits to the order routing computer 102 data for an order to sell a quantity identical to the value displayed in the region 236 of the product at the highest bid price, the value of which is displayed in the region 212a.

The trader may click in a region 242 or 244 to direct the trading computer 100 to generate and transmit to the order routing computer 102 data representing an order to offer for sale or bid to purchase, respectively, a quantity of the product, wherein such quantity is shown in the region 236, at a price equal to the lowest offer or highest bid price, as the case may be.

As noted above, each region 228a, 228b, 228c, . . . , and 228M of the column 226 is associated with one of the regions 212a, 212b, 212c, . . . , and 212M, respectively, of the column 210. If the trader selects one of the regions of the column 226, the trading computer 100 generates and transmits to the order routing computer 102 an order to purchase the product at a price that is equal to the value displayed in the region of column 210 that is associated with the selected region. For example, if the trader selects the region 228b, the trading computer 100 generates and transmits data for an order to purchase the product at price identical to the value displayed in the region 212b (that is, for $93.22 per unit). The quantity of the order is identical to the value displayed in the region 236.

Similarly, if the trader selects one of the regions of the 232a, 232b, 232c, . . . , and 232N of the column 230, the trading computer 100 generates and transmits an order to sell the product at a price that is identical to the value displayed in one of the regions 216a, 216b, 216c, . . . , and 216N of the column 214 associated with the selected region.

If the trader wishes to enter an order at a price that is not displayed in one of the regions of the columns 214 and 210, the trader may select one of the regions 252 and 254. Selecting the region 252 scrolls the regions of columns 226, 218, 210, 222, and 230 upwardly so that one additional region is added to the columns 226, 218, and 210 and a region is removed the columns 222, and 230. Similarly, selecting the region 254 scrolls the regions of columns 226, 218, 210, 222, and 230 downwardly so that one additional region is added to the columns 210, 222, and 230 and one region is removed from the columns 226 and 218. The columns 226, 218, 210, 222, and 230 remain in the scrolled position until the trader enters or cancels an order as described above or until the trader selects another region of display. In some embodiments, the columns 226, 218, 210, 222, and 230 remain in the scrolled position for a predetermined amount of time without any input from the trader. Alternately, the columns 226, 218, 210, 222, and 230 may return to their unscrolled positions after a predetermined amount of time after the selection by the trader of the regions 252 or 254 elapses.

The trading computer 100 may allow the trader to select a region in different ways. For example, if the trader uses a mouse associated with trading computer 100 and such mouse has a left and a right button, the trader may be able to select a region by positioning a cursor with the mouse and clicking on the region using the left or the right mouse button. In some embodiments, if the trader selects one of the regions of the columns 226 and 230 using the left mouse button, the trading computer 100 generates and transmits data for an order as described above. However, if the trader selects such a region with the right mouse button, the trading computer 100 generates and transmits data via the order routing computer 102 to the trading host 104 to direct the trading host 104 to cancel any orders that may be pending at the price associated with such region.

Similarly, if the trader uses a trading computer 100 that has a touch screen, the left mouse button and right mouse button behavior described above may be accomplished by using different gestures to select a region. For example, touching a region of the columns 226 and 230 with one finger may cause the trading computer 100 to generate and send an order at a price associated with such region. In some embodiments, touching the region with two fingers may cause the trading computer 100 to send data to the order routing computer 102 that directs the trading host 104 to cancel any orders for the trader pending at the price associated with the region. It should be apparent that the trading computer 100 may allow the use of other types of user input devices and/or gestures and/or any other input modalities to enable the trader to select a region and thereby enter or cancel an order.

In a preferred embodiment, the data generated by the trading computer 100 and transmitted to the order routing computer 102 are in accordance with the Financial Information Exchange (“FDX”) protocol and are encoded using the FIX markup language (FIXML) defined by the FIX Protocol Ltd., London, United Kingdom. The protocol is published, for example, in FINANCIAL INFORMATION EXCHANGE PROTOCOL (FIX) Version 5.0 Service Pack 2, Vols. 1-7, April 2009, and available for download from http://www.fixprotocol.org. Further, in the preferred embodiments the information transmitted by the trading computer 100 to the order routing computer 102 is encrypted as provided by the FIX protocol. It should be apparent that protocols other than FIX, including proprietary protocols, may be used to exchange information between the trading computer 100 and the order routing computer 102.

The graphical user interface 200 includes regions 246 and 248 for withdrawing from the market any unmatched offers and bids, respectively, previously submitted by the trader. In particular, if the trader selects the regions 246 or 248, the trading computer 100 generates and transmits to the order routing computer 102 data that directs the trading host 104 to remove any pending offers or bids, respectively, previously entered by the trader. The trader may select the region 250 to direct the trading computer 100 to generate and transmit to the order routing computer 102 data that directs the trading host 104 to remove from the marker all pending offers and bids previously entered by the trader.

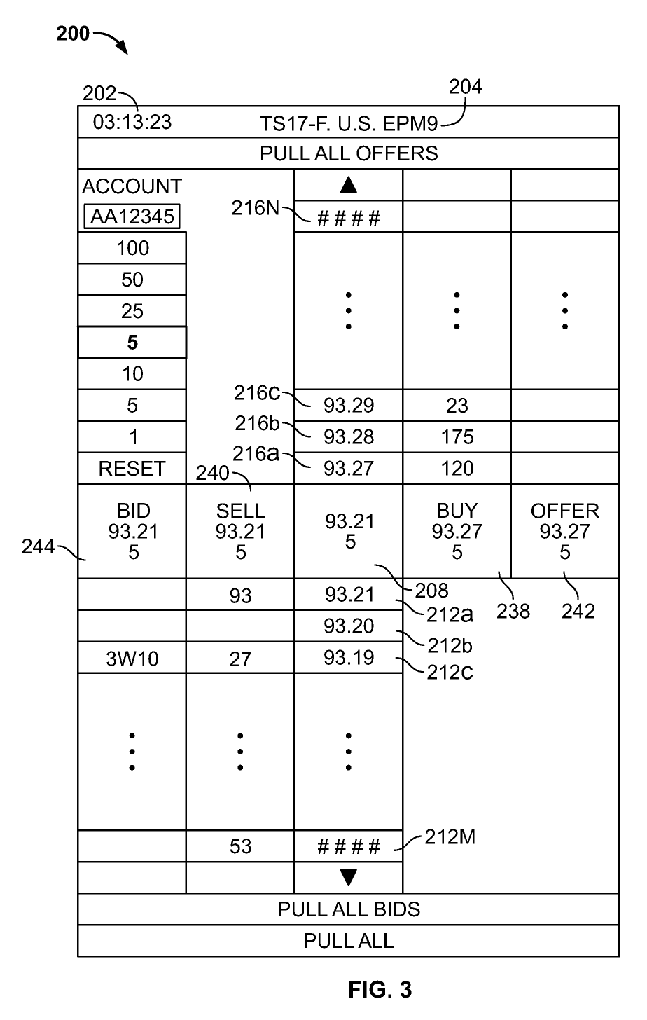

FIG. 3 is the graphical user interface 200 as shown in FIG. 2 after some time has elapsed. Certain reference numbers appearing in FIG. 2 are not replicated in FIG. 3 for purposes of clarity. The location of regions of the graphical user interface 200 illustrated in FIG. 3 are identical to those of the graphical user interface 200 illustrated in FIG. 2. However, the values shown in such regions have been updated in accordance with data received by the trading computer 100. In particular the region 208 displays the last received value of the last trade at or before the time displayed in the region 202 and, similarly, the regions 212a and 216a display the last received values of the inside market, that is, the highest bid price and the lowest offer price, respectively, at the time displayed in the region 202.

The values displayed in the regions 212b, 212b, 212c, . . . , and 212M are derived from the value shown in the region 212a and the tick size as described above. The values displayed in the regions 216a, 216b, 216c, . . . , and 216N are derived from the value displayed in the region 216a and the tick size as described above.

The values displayed in the regions 238 and 240 have been changed in FIG. 3 as compared to FIG. 2 in accordance with the inside market values shown in the cells 216a and 212a, respectively.

Although FIGS. 2 and 3 show the states of the graphical user interface 200 at two discrete points in time, it should be apparent the trading computer 100 may update values substantially continuously in accordance with data received from the trading computer 102 and selections made by the trader or may update values at discrete intervals.

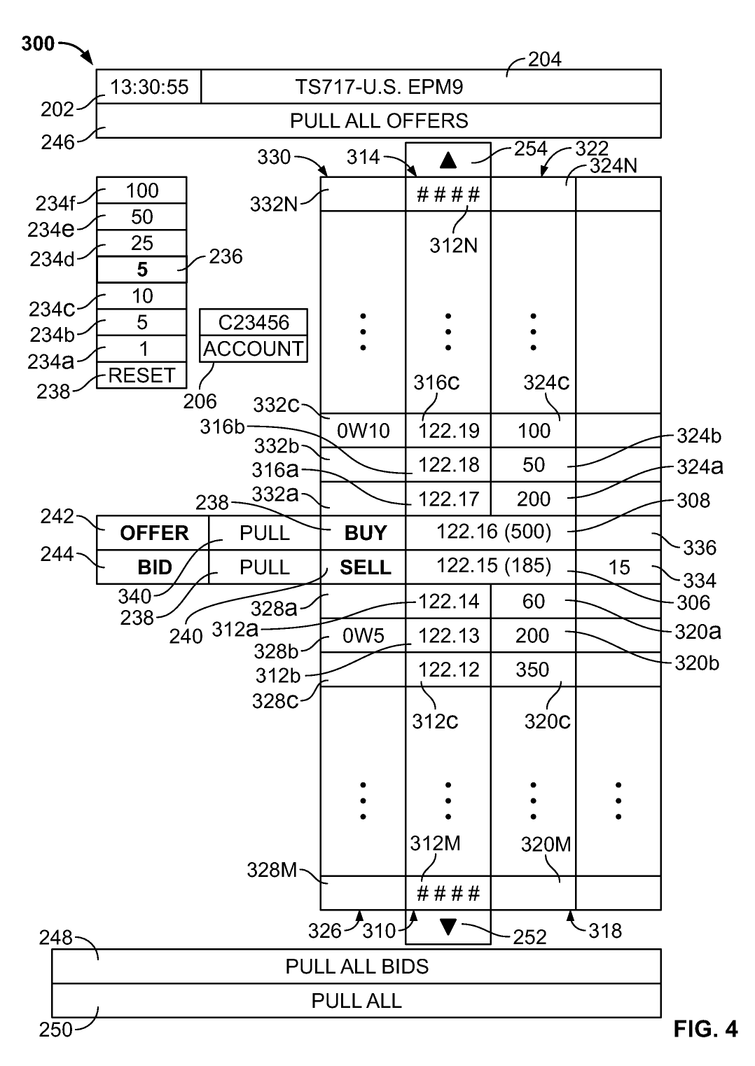

FIG. 4 is another representation of a graphical user interface 300 of the trading computer 100 to display orders in an order book associated with a product and to allow the trader to specify orders that are sent to the exchange 106. In particular, the graphical user interface 300 comprises regions substantially identical to the regions of the graphical user interface 200 shown in FIGS. 2 and 3, but the locations where such regions appear relative to one another are different. Regions in FIG. 4 and corresponding regions of FIGS. 2 and 3 that have identical reference numbers display the same type of information and react to input by the trader identically to one another described above with respect to FIGS. 2 and 3.

The graphical user interface 300 includes regions 306 and 308 in which values of the prices at the inside market and values of the quantities associated with orders at such prices are displayed. In particular, the price and total quantity associated with orders in the order book that have the highest bid price are displayed in the region 306, wherein the quantity is displayed inside parentheses. Similarly, the price and total quantity associated with orders in the order book that have the lowest offer price are displayed in the region 308. The graphical user interface 300 comprises a column 310 that includes regions 312a, 312b, 312c, . . . , and 312M, in which values less than the price shown in the region 306 are displayed. Typically, the value displayed in the region 312a is the value of the price displayed in the region 306 less the tick size associated with the product, and the value displayed in the region 312b is the value of the price displayed in the region 312a less the tick size. The values displayed in the regions 312c, . . . , 312M decrease by one tick size in a similar fashion.

A column 314 includes regions 316a, 316b, 316c, . . . , and 316N in which values greater than the price shown in the region 308 are displayed. Typically, the value displayed in the region 316a is the value displayed in the region 308 plus the tick size and the value displayed in the region 316b is the value displayed in the region 316a plus the tick size. The values displayed in the remaining regions 316c, . . . , and 316N are increased by the tick size in a similar fashion.

A column 318 comprises regions 320a, 320b, 320c, . . . , and 320M associated with the regions 312a, 312b, 312c, . . . , and 312M, respectively, and in each such region 320 a value of the quantity of the product available for purchase in the market at the price displayed in the region 312 associated therewith is displayed. A column 322 comprises regions 324a, 324b, 324c, . . . , and 324N and in each such region is displayed a value of the quantity of the product available for sale at a price displayed in the regions 316a, 316b, 316c, . . . , and 316N associated therewith, respectively.

A column 326 comprises regions 328a, 328b, 328c, . . . , and 328M associated with the regions 312a, 312b, 312c, . . . , and 312M, respectively. Information regarding matched and pending orders submitted by the trader for the price in the region 312 is displayed in each such region 328 associated therewith. Similarly, a column 330 comprises regions 332a, 332b, 332c, . . . , and 332N associated with the regions 316a, 316b, 316c, . . . , and 316N and in each such region 332 is displayed information regarding matched and pending orders submitted by the trader for the price displayed in the region 316 associated therewith.

The format in which information displayed in the regions 328 and 332 may be identical to the format used to display similar information in the regions 228 and 232 described above.

The trader may select one of the regions comprising columns 326 and 330 to enter new orders or cancel pending orders in a manner identical to that described above with respect to the regions comprising columns 226 and 230.

FIG. 4 further includes a region 334 that shows the total quantity of any orders the trader has in the order book to buy the product at the inside market price (i.e, at the highest bid price). For example, in FIG. 4, the value “15” in the region 334 indicates that the trader has previously submitted one or more pending orders to purchase a total of 15 units of the product at $122.15 per unit. A region 336 shows the a value of the total quantity associated with any orders in the order book the trader has pending to sell the product at the inside market (i.e., at the lowest offer price). In FIG. 4, the region 336 does not show any value, thereby indicating that the trader does not have any pending orders to sell the product at the inside market.

If the trader selects a region 338 of the graphical user interface 300, the trading computer 100 generates and sends to the order routing computer 102 data representing a directive for the trading host 104 to remove from the order book all buy orders previously submitted by the trader at the inside market that have not been matched (i.e., all orders that are associated with the quantity shown in region 334). Similarly, if the trader selects a region 340, the trading computer 100 generates and sends to the order routing computer 102 data representing a directive for the trading host 104 to remove all pending sell orders previously submitted by the trader at the inside market (i.e., all orders associated with the quantity shown in region 336).

In some embodiments, the total quantities of any orders the trader has in the order book to buy and sell the product at the inside market price are displayed in the regions 340 and 238, respectively, instead of the string “PULL.”

Some embodiments of the graphical user interface do not include regions 242 and 244. In such embodiments, the trader may click the region 306 or 308 to direct the trading computer 100 to generate and transmit to the order routing 102 data representing an order to offer for sale or bid to purchase, respectively, a quantity of the product, wherein such quantity is shown in the region 236, at a price equal to the lowest offer or highest bid price, as the case may be.

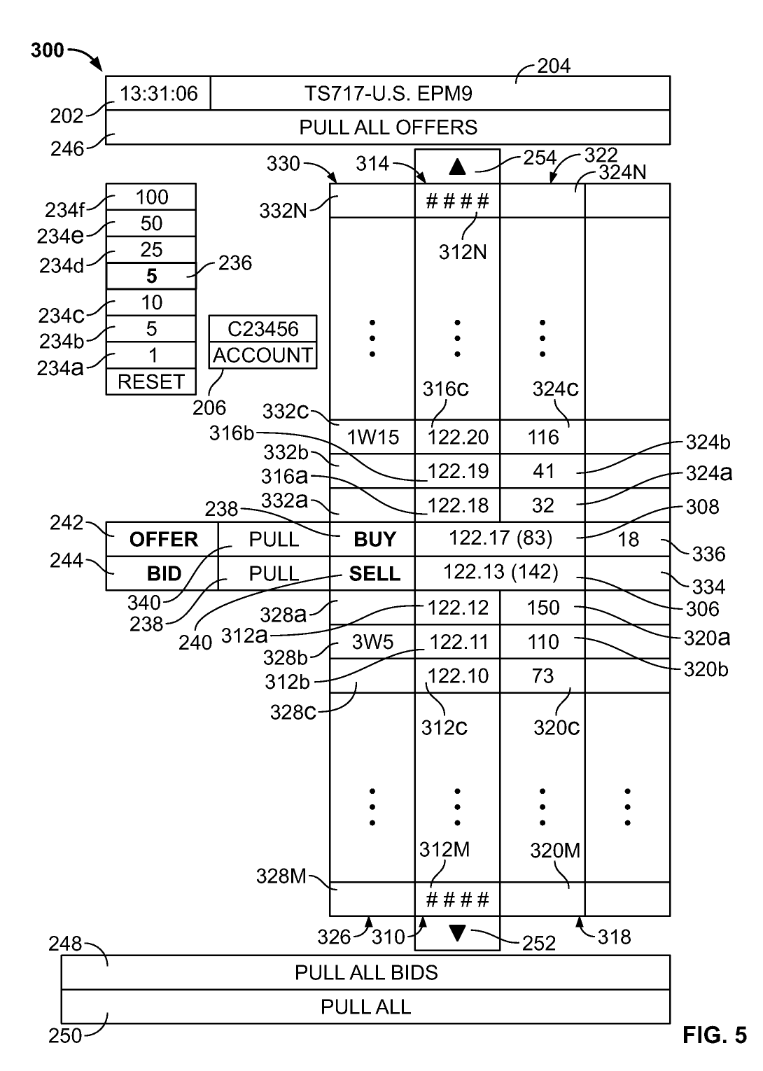

FIG. 5 depicts the graphical user interface 300 of FIG. 4 after a period of time has elapsed (as indicated by a comparison of the values shown in region 202 of FIG. 4 and FIG. 5). Because the inside market has changed, the values shown in the regions 306 and 308 and the regions that comprise columns 310, 314, 318, 322, 326, and 330 have changed. It should be noted that the locations of such regions relative to one another or other regions of the graphical user interface 300 have not changed in response to the receipt of new data.

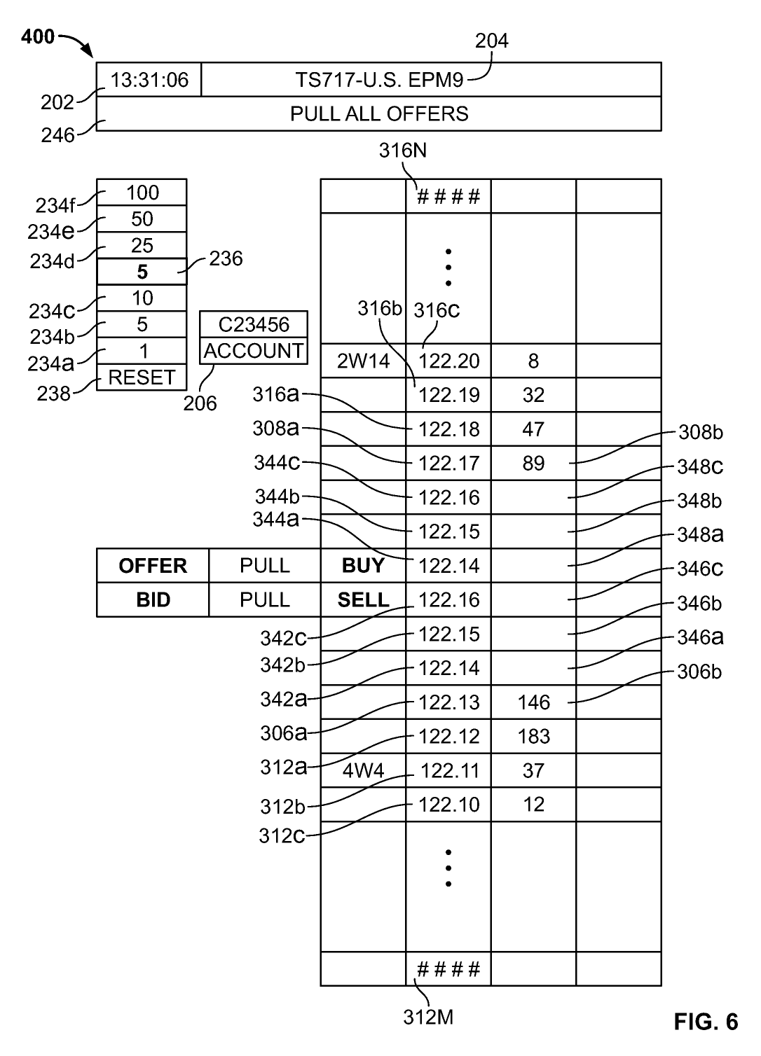

If the trader wishes to enter an order to purchase or sell the product at a price that is between the prices associated with the inside market, that is, between the highest bid price and the lowest offer price shown in the regions 306 and 308, the trader may select the region 306 or the region 308. Selecting such regions causes the trading computer to generate the graphical user interface 400 shown in FIG. 6. The regions 342a, 342b, 342c, 344a, 344b, and 344c are inserted between the regions 306 and 308. Identical values are displayed in the regions 342a and 344a and such values are the highest bid price (i.e., the value shown in region 306a) plus the tick size. The values displayed in the regions 342b and 344b are also identical and are equal to the sum of the values shown in 342a and 344b and the tick size. The values displayed in the regions 342c and 344c are also identical and are the value of the sum of the values in the regions 342b and 344b plus the tick size. The number of regions inserted between the regions 306 and 308 is equal to twice the number of ticks between the highest bid price and lowest offer price that comprise the inside market. Further, in some embodiments, the region 306 is split into regions 306a and 306b and the highest bid price is shown in region 306a and the total quantity of the product desired by all traders at such price is shown in the region 306b. Similarly, the region 308 may be split into regions 308a and 308b and the lowest offer price is displayed in the region 308a and the total quantity available for purchase at such price from all traders is displayed in the region 308b.

Additional regions 346a, 346b, and 346c associated with regions 342a, 342b, and 342c, respectively, are also inserted. The trader may select one of the regions 346 to enter a new order to purchase the product or cancel a previously entered order at the price associated with such region as described above.

Regions 348a, 348b, and 348c associated with regions 344a, 344b, and 344c, respectively, are also inserted. The trader may select one of the regions 348 to enter a new order to sell the product or cancel a previously entered order at the price associated with such region as described above.

It should be noted that in the foregoing where a one-to-one correspondence between two groups of regions described, such correspondence, in some embodiments, may be one-to-many or many-to-one. For example, the regions 212a, 212b, 212c, . . . , 212M in which prices are displayed are described as having a one-to-one correspondence with regions 220a, 220b, 220c, . . . , and 220M in which quantities associated with such prices are displayed. However, it should be apparent that more than one region may be used to display the quantities in the market associated with each price or the same price may be displayed in more than one region.

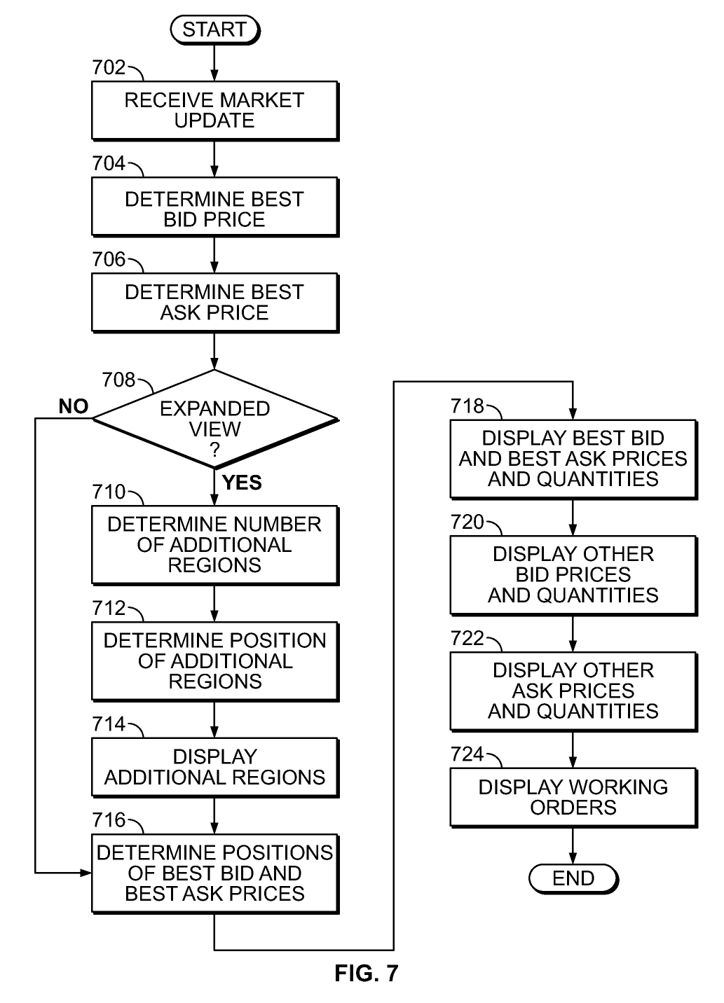

FIG. 7 displays a flow chart of the processing undertaken by the trading computer 100 to generate and/or modify the graphical user interface displayed thereon in response to receiving updated market data. A block 702 receives the updated market data and a block 704 analyzes the received market data to determine the highest bid price and a block 706 analyzes the received market data to determine the lowest offer price. A block 708 determines if the trader has selected the expanded view illustrated in FIG. 6, and if such view has been selected, a block 710 determines the number of additional regions 342 and 344 that should be displayed. A block 712 determines where on the display of the trading computer 100 the additional regions 342 and 344 should be placed. A block 714 displays the additional regions 342 and 344 at the determined locations.

A block 716 determines the locations on the display of the trading computer 100 in which to display the highest bid and lowest offer price, for example, the locations of the regions 212a and 216a, respectively, of FIGS. 2 and 3, the regions 306 and 308, respectively, of FIGS. 4 and 5, or the regions 306a and 308a, respectively of FIG. 6. If needed, the block 716 also determines the locations of the region 208, if such region is to be displayed.

A block 718 displays the values of the highest bid price and quantity, lowest offer price and quantity, and, if necessary, the values of the last traded price and quantity in the region 208 at the location of such region determined by the block 716. A block 720 determines the locations of the regions in which to display values of prices that are less than the highest bid price, and the regions in which to display quantities and any pending orders associated with such prices. A block 722 displays the values of the prices less than the highest bid price and the quantities and working orders associated therewith at the locations determined by the block 720. The block 722 may also display the information regarding the last traded price.

A block 724 determines the positions of the regions in which to display values of the prices that are greater than the lowest offer price and quantities and pending orders associated therewith and the block 726 displays the values of the prices, quantities, and working orders in such regions.

If the block 708 determines that the expanded view should not be displayed, processing proceeds from the block 708 to the block 716.

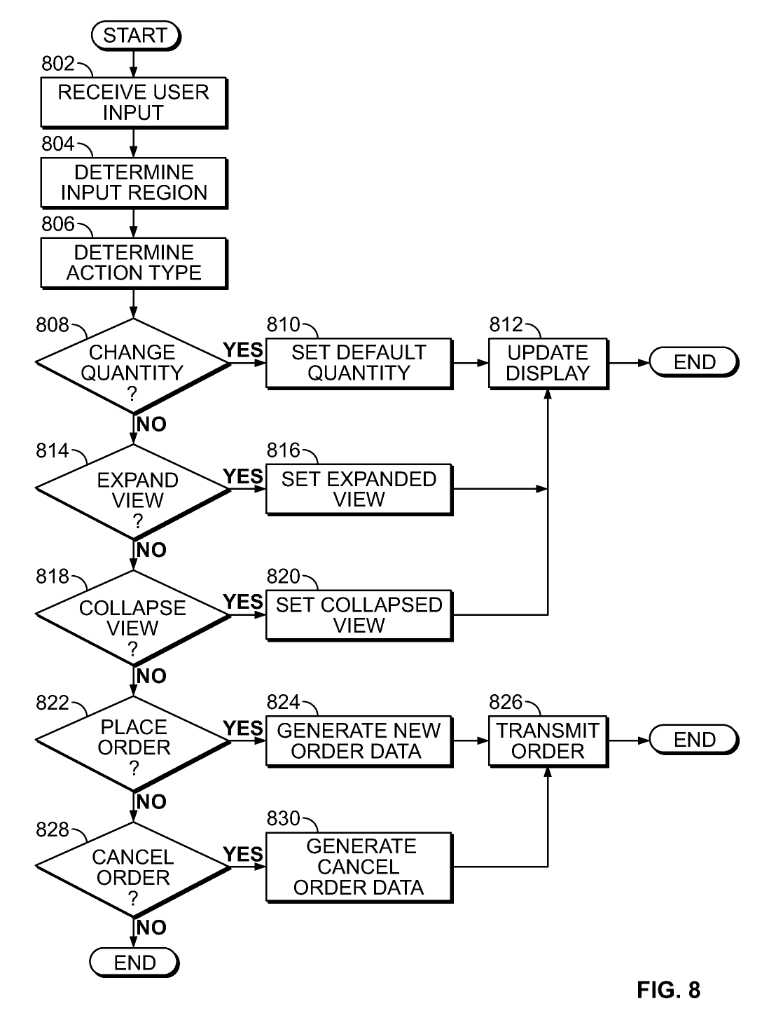

FIG. 8 is a flowchart of processing undertaken by the trading computer 100 in response to an input by the trader. A block 802 receives the input, which may be a single or a double mouse click, a single touch of a finger or implement, a touch using more than one finger, a swipe across a portion of the display, a press of a key on keyboard, and the like. In some embodiments, the input may be a combination of inputs from one or more input devices, for example, a key press combined with a mouse click.

A block 804 determines a region, if any, of the display with which the action is associated. For example, the block 804 may compare the coordinate(s) of one or more pixel(s) where the action was initiated or terminated with coordinates and dimensions of each region of the graphical user interface displayed on the screen of the trading computer 100. Thereafter, the block 804 selects a region that includes within the boundary thereof the pixel(s) where the action occurred.

A block 806 determines analyzes the input received by the block 802 and region determined by the block 804 to determine an action the trading computer 100 should undertake.

A block 808 checks to determine if the action is to change the default quantity. If this is found to be the case, a block 810 determines the new default quantity selected by the trader and a block 812 displays a value of the new default quantity in the region 236 of the graphical user interface 100. Thereafter, processing returns to the block 802 to await a further input from the trader.

If the block 808 determines that the action is not to change the default quantity, a block 814 checks whether the action is to expand the view by inserting additional regions for displaying prices between the highest bid and lowest offer prices. If this is found to be the case, a block 816 sets a view variable to indicate that the expanded view should be displayed and the block 812 updates the display with the expanded view. Otherwise, a block 818 checks whether the action is to collapse the view, that is, to hide regions for displaying prices between the highest bid price and lowest offer price. If this is found to be the case, a block 816 sets the view variable to indicate that the collapsed view should be displayed and proceeds to the block 812 to update the view. The block 708 checks the view variable set by the blocks 816 and 820 to determine whether the expanded view should be displayed.

If the block 818 determines that the action is not to change the view, then a block 822 determines if the action is to generate a new order. If the block 822 determines that a new order is to be generated, the block 824 determines the price associated with the new order based on the region determined by the block 804 and generates data for an order with such price and the default quantity, for example, as set by the block 810. A block 826 transmits the data for the order to the order routing computer 102.

If the block 822 determines that a new order is not to be placed, a block 828 determines whether the action is to cancel a previously submitted order or to cancel one or more orders from the order book. If one or more previously submitted orders are to be cancelled, a block 830 determines which order(s) to cancel and generates data to direct the trading host 104 to cancel the orders and the block 826 transmits such data to the order routing computer 102.

It should be apparent that the trading computer 100 may be programmed to act on actions other than the ones described hereinabove. Further, it should be apparent that the operating system that executes on the trading computer 100 may provide facilities for evaluating inputs by the trader received thereby and determining the location(s) of the display at which such inputs occurred.

It should be apparent that the trading computers 100a, 100b, . . . , and 100N may all be identical or different. Further each such computer may be a desktop personal computer or a laptop or any type of portable personal computer and may operate a version of Windows® operating system developed by the Microsoft Corporation of Redmond, Wash., or a version of the Macintosh® operating system developed by Apple Computer, Inc, of Cupertino, California. Software operating on such computers that provide the functionality of the systems and methods described above may be implemented using any of a variety of computer programming languages including Visual Basic, C, C#, C++, Objective-C, Java and the like. Further, it should be apparent that one or more of the trading computers 100 may be “smart” telephones or information devices such as an iPhone® or iPad® manufactured by Apple Computer, Inc, a telephone manufactured by a variety of manufactures that uses the Android operating system developed by Google, Inc., of Mountain View, Calif., and/or the like.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I claim:

1. A method of displaying market information, wherein the method comprises the steps of:
(a) receiving data regarding a change in an inside market for a product traded using a trading host;
(b) determining a value of a highest bid price and a value of a lowest ask price;
(c) displaying the value of the highest bid price in a first region of a screen;
(d) displaying the value of the lowest offer price in a second region of screen;
(e) displaying a plurality of values less than the value of the highest bid price in a first plurality of regions; and
(f) displaying a plurality of values greater than the value of the lowest offer price in a second plurality of regions;
wherein the steps (b) through (f) are undertaken each time the data representing a change in the inside market is received and the locations of the first region, the second region, the first plurality of regions, and the second plurality of regions relative to one another remain substantially constant even when the inside market changes.

2. The method of claim 1, wherein the method includes the steps of receiving an input from an input device and, responsive to the input, transmitting data associated with an order to the trading host.

3. The method of claim 1, wherein the step of transmitting data includes the step of transmitting data associated with one of a request to submit a new order and a request to cancel an order.

4. The method of claim 2, wherein the step of transmitting data include the step of transmitting data to an order routing computer.

5. The method of claim 1, wherein the method includes the step of receiving an input from an input device at a region associated with the first region or the second region and displaying a value that is between the value of the highest bid price and the value of the lowest ask price.

6. The method of claim 5, wherein the step of displaying the value between the value of the highest bid price and the value of the lowest ask price comprises the step of displaying such value in a plurality of regions of the screen.

7. A system for displaying market information for a product traded using a trading host, comprising:
a screen, wherein the screen includes:
a first region for displaying a value of a highest bid price for the product,
a second region for displaying a lowest offer price for the product,
a first plurality of regions for displaying values less than the highest bid price, and
a second plurality of regions for displaying values greater than the lowest ask price; and
a programmable processor that receives data representing a change in an inside market from the trading host, determines the value of a highest bid price and the value of a lowest ask price from the received data, and displays the value of the highest bid price and the value of the lowest offer price in the first and second regions of the screen, respectively;
wherein the locations of the first region, the second region, the first plurality of regions, and the second plurality of regions relative to one another remain substantially constant even when the inside market changes.

8. The system of claim 7, wherein the system includes a user input device and the processor receives an input from the input device and, responsive to the input, transmits data associated with an order to the trading host.

9. The system of claim 8, wherein the transmitted data is associated with one of a request to submit a new order and a request to cancel an order.

10. The system of claim 8, wherein the processor transmits the data to an order routing computer.

11. The system of claim 7, wherein the system includes a user input device from which the processor receives an input, wherein the input is associated with the first region or the second region and, in response, the processor displays on the screen a value that is between the value of the highest bid price and the value of the lowest ask price.

12. The system of claim 11, wherein the processor displays the value that is between the value of the highest bid price and the value of the lowest ask price in a plurality of regions of the screen.

13. An apparatus for displaying market information, comprising:
means for repeatedly receiving data regarding a change in an inside market for a product traded using a trading host;
means for determining a value of a highest bid price and a value of a lowest ask price;
means for displaying the value of the highest bid price in a first region of a screen;
means for displaying the value of the lowest offer price in a second region of the screen;
means for displaying a plurality of values less than the value of the highest bid price in a first plurality of regions; and
means for displaying a plurality of values greater than the value of the lowest offer price in a second plurality of regions;
wherein the locations of the first region, the second region, the first plurality of regions, and the second plurality of regions relative to one another remain substantially constant even when the inside market changes.

14. The apparatus of claim 13, wherein the apparatus includes means for receiving an input and means responsive to the input for transmitting data associated with an order to the trading host.

15. The apparatus of claim 14, wherein the transmitted data is associated with one of a request to submit a new order and a request to cancel an order.

16. The apparatus of claim 14, wherein the transmitting means includes means for transmitting the data to an order routing computer.

17. The apparatus of claim 13, wherein the apparatus includes means for receiving an input, wherein the input is associated with the first region or the second region, and means responsive to the input for displaying a value that is between the value of the highest bid price and the value of the lowest ask price.

18. The apparatus of claim 17, wherein the displaying means includes means for displaying a value that is between the value of the highest bid price and the value of the lowest ask price in a plurality of regions of the screen.

19. A computer program product for displaying market information, comprising a computer-readable storage medium, the computer-readable storage medium having computer-executable program code stored thereon that, when executed, causes a computer to:
(a) receive data regarding a change in an inside market for a product traded using a trading host;
(b) determine a value of a highest bid price and a value of a lowest ask price;
(c) display the value of the highest bid price in a first region of a screen;
(d) display the value of the lowest offer price in a second region of the screen;
(e) display a plurality of values less than the value of the highest bid price in a first plurality of regions; and
(f) display a plurality of values greater than the value of the lowest offer price in a second plurality of regions;
wherein the computer undertakes (b) through (f) each time the data representing a change in the inside market is received and the locations of the first region, the second region, the first plurality of regions, and the second plurality of regions relative to one another remain substantially constant even when the inside market changes.

20. The computer program product of claim 19, wherein the program code causes the computer receive an input and, responsive to the input, transmit data associated with an order to the trading host.

21. The computer program product of claim 20, wherein the transmitted data is associated with one of a request to submit a new order and a request to cancel an order.

22. The computer program product of claim 21, wherein the program code causes the computer to transmit the data to an order routing computer.

23. The computer program product of claim 21, wherein the computer receives an input from an input device, wherein the input is associated with the first region or the second region, and, response to the input, the program product causes the computer to display a value that is between the value of the highest bid price and the value of the lowest ask price.

24. The computer program product of claim 23, wherein program product causes the computer to display the value that is between the value of the highest bid price and the value of the lowest ask price in a plurality of regions of the screen.

25. An apparatus for trading using a trading host, comprising:
means for displaying on a screen a first value associated with a highest bid price in the market and a second value associated with a lowest offer price in the market;
means for receiving a first input in a region of the screen associated with the first value or the second value;
means responsive to the first receiving means for displaying a third value that is greater than the first value and less than the second value;
means for receiving a second input in a region of the screen associated with the third value; and
means responsive to the second receiving means for transmitting data associated with an order to the trading host, wherein the price associated with the order is determined in accordance with the third value.
